(19) United States
(12) Patent Application Publication
(10) Pub. No.: US 2018/0048514 A1
(43) Pub. Date: Feb. 15, 2018

(54) MECHANISM TO SUPPORT OPERATOR ASSISTED PARENTAL CONTROL

(71) Applicant: NOKIA SOLUTIONS AND NETWORKS OY, Espoo (FI)

(72) Inventors: Swaminathan ARUNACHALAM, Plano, TX (US); Ram LAKSHMI NARAYANAN, Pleasanton, CA (US)

(21) Appl. No.: 15/553,730

(22) PCT Filed: Feb. 25, 2015
(86) PCT No.: PCT/US2015/017526

§ 371 Date: Aug. 25, 2017

(51) Int. Cl. H04L 29/06; H04L 29/08

(52) U.S. Cl. CPC H04L 29/06; H04L 67/02; H04L 63/20; H04L 67/22

(57) ABSTRACT

Certain embodiments of the invention generally relate to mobile communications. For example, some embodiments relate to mechanism(s) to support operator assisted parental control of encrypted traffic in wireless networks. A method may include receiving parental control policy information of a subscriber from a network entity in a core network, and initiating parental control policy enforcement according to the parental control policy information. The parental control policy enforcement is initiated in at least one of a mobile network entity or an application service provider.

### BACKGROUND

### Field

Embodiments of the invention generally relate to mobile communications networks, such as, but not limited to, the Universal Mobile Telecommunications System (UMTS) Terrestrial Radio Access Network (UTRAN), Long Term Evolution (LTE) Evolved UTRAN (E-UTRAN). For example, some embodiments relate to mechanism(s) to support operator assisted parental control of encrypted traffic in wireless networks.

### Description of the Related Art

Universal Mobile Telecommunications System (UMTS) Terrestrial Radio Access Network (UTRAN) refers to a communications network including base stations, or Node-Bs, and radio network controllers (RNC). UTRAN allows for connectivity between the user equipment (UE) and the core network. The RNC provides control functionalities for one or more Node-Bs. The RNC and its corresponding Node-Bs are called the Radio Network Subsystem (RNS).

Long Term Evolution (LTE) refers to improvements of the UMTS through improved efficiency and services, lower costs, and use of new spectrum opportunities. In particular, LTE is a 3rd Generation Partnership Project (3GPP) standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and multimedia transport in addition to high-capacity voice support. Advantages of LTE include, for example, high throughput, low latency, FDD and TDD support in the same platform, an improved end-user experience, and a simple architecture resulting in low operating costs. In addition, LTE is an all Internet protocol (IP) based network, supporting both IPv4 and Ipv6.

### SUMMARY

One embodiment is directed to a method that includes receiving parental control policy information of a subscriber from a network entity in a core network. In an embodiment, the method may also include initiating parental control policy enforcement according to the parental control policy information. In an embodiment, the parental control policy enforcement may be initiated in at least one of a mobile network entity or an application service provider.

In an embodiment, the initiating may include performing at least one of implementing parental control policy enforcement according to the parental control policy information, or sending a request to the application service provider to implement parental control policy enforcement according to the parental control policy information. In an embodiment, the method may further include receiving subscriber application usage or activity information, in which the subscriber application usage or activity information is received either in-band via a protocol header, or via a dedicated off-band control connection.

In an embodiment, the method may also include passing the subscriber application usage or activity information to the network entity. In an embodiment, the method may further include receiving specific content type information of the subscriber according to the parental control policy information from an application service provider. According to an embodiment, the specific content type information may include content designated for a specific age of a user.

In an embodiment, the method may further include implementing parental control policy enforcement according to the specific content type information. In an embodiment, the request for parental control policy information from the network entity may be sent near-real time at an uplink or downlink interface. According to an embodiment, the subscriber application usage or activity information may be collated to create a report that is shared to the subscriber on a need basis. In an embodiment, the report may include at least one of visited sites reports, harmful and suspicious site alerts including user-generated site categories, mail and social network communication visibility, instant messaging communications visibility, reports on search engine usage, or extended social graph view.

According to an embodiment, the parental control policy information may be obtained from a core network entity. In an embodiment, the core network entity may include a policy and charging rules function or an evolved packet core. According to an embodiment, the parental control policy enforcement may include a universal resource locator, content, or advertisement filtering.

Another embodiment is directed to an apparatus, which may include at least one processor, and at least one memory including computer program code. The at least one memory and the computer program code may be configured, with the at least one processor, to cause the apparatus at least to receive parental control policy information of a subscriber from a network entity of a core network. In an embodiment, the at least one memory and the computer program code may also be configured, with the at least one processor, to cause the apparatus at least to initiate parental control policy enforcement according to parental control policy information. According to an embodiment, the parental control policy enforcement may be initiated in at least one of a mobile network entity or an application service provider.

Another embodiment is directed to an apparatus, which may include receiving means for receiving parental control policy information of a subscriber from a network entity in a core network. The apparatus may also include initiating means for initiating parental control policy enforcement according to the parental control policy information. In an embodiment, the parental control policy enforcement is initiated in at least one of a mobile network entity or an application service provider.

According to an embodiment, the initiating means may include means for performing at least one of implementing parental control policy enforcement according to the parental control policy information, or means for sending a request to the application service provider to implement parental control policy enforcement according to the parental control policy information. In an embodiment, the apparatus may further include receiving means for receiving subscriber application usage or activity information, in which the subscriber application usage or activity information may be received either in-band via a protocol header, or via a dedicated off-band control connection.

In an embodiment, the apparatus may also include passing means for passing the subscriber application usage or activity information to the network entity. According to an embodiment, the apparatus according may further include receiving means for receiving specific content type information of the subscriber according to the parental control policy information from an application service provider. In an embodiment, the specific content type information may include content designated for a specific age of a user.

According to an embodiment, the apparatus may also include implementing means for implementing parental control policy enforcement according to the specific content type information. In an embodiment, the request for parental control policy information from the network entity is sent near-real time at an uplink or downlink interface. According to an embodiment, the subscriber application usage or activity information is collated to create a report that is shared to the subscriber on a need basis.

In an embodiment, the report may include at least one of visited sites reports, harmful and suspicious site alerts including user-generated site categories, mail and social network communication visibility, instant messaging communications visibility, reports on search engine usage, or extended social graph view. According to an embodiment, the parental control policy information is obtained from a core network entity.

In an embodiment, the core network entity may include a policy and charging rules function or an evolved packet core. According to an embodiment, the parental control policy enforcement may include a universal resource locator, content, or advertisement filtering. In an embodiment, a computer program may be embodied on a non-transitory computer readable medium, the computer program configured to control a processor to perform the method described above.

### BRIEF DESCRIPTION OF THE DRAWINGS

For proper understanding of the invention, reference should be made to the accompanying drawings, wherein:

FIG. 1 illustrates a group of logical entities, according to certain embodiments.

FIG. 2 illustrates an example implementation in an MEC platform of a mobile network, according to certain embodiments.

FIG. 3 illustrates an ASP assisted parental policy control implementation (Approach A), according to certain embodiments.

FIG. 4 illustrates an ASP assisted parental policy control implementation (Approach B), according to certain embodiments.

FIG. 5 illustrates an example of a system according to certain embodiments.

FIG. 6 illustrates an apparatus, according to certain embodiments.

FIG. 7 illustrates an example of a flow diagram of a method, according to certain embodiments.

FIG. 8 illustrates another example of a flow diagram of a method, according to certain embodiments.

### DETAILED DESCRIPTION

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments. Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Mobile phone service providers may have different options for controlling privacy and usage, filtering content. With usage policy controls, service providers may allow parents to turn OFF or ON certain specific features. Example user control may include downloading videos or images, texting, and accessing Internet websites etc. More flexibility is given to the user as control may be based on location or based on time, etc. With content filtering controls, parents may block certain websites to allow for safer mobile browsing on the Internet. Some filters may also limit videos and other multimedia.

In addition to the control of web content by itself, advertisements may also be controlled depending on the mobile device user's age group. For example, when a child under age 7 is watching a cartoon movie, advertisement appropriate for that age may be embedded. There are practices such as Online Behavioral Advertising (OBA) developed in the industry to handle this requirement. Traditional television advertisements focus on demography such as zip code, whereas OBA tailor Internet advertising based on an individual's online history and behavior.

OBA is generally concerned with third-party behavioral advertising, in which a third-party ad company tracks an individual's web usage history across multiple sites in order to target advertisements. In the United States, third-party OBA is generally governed through advertising industry self-regulation, overseen by industry groups. Collecting data to measure behavioral targeting is a complex process, on account of confounding factors such as IP address, browser fingerprints, and Locally Shared Objects (LSOs). Most of these OBA tools use cookies.

On the contrary, there are privacy-enhancing methods such as opt-out from service, cookies used for blocking, and Do Not Track (DNT), which disallows OBA to be ineffective. In particular, opt-out cookies allow users to specify their desire to “opt-out” of behavioral advertising, storing this request in a cookie on their computer. Opt-out cookies can also be set and read by each individual ad agency.

Further, “blocking” tools prevent tracking and third-party advertising by refusing content (such as cookies or scripts) from specific domains on a blacklist. Additionally, from the browsers, there are new W3C definitions to opt out of DNT.

With the introduction of privacy-enhancing tools and the growing rate of internet traffic encrypted with secure sockets layer (SSL) over access networks, the ability to execute parental control of the user traffic within the mobile operator network using traditional deep packet inspection (DPI) technologies is becoming impossible.

Host-based (user equipment (UE)) and network-based are two existing popular techniques to perform filtering of content. However, there are several shortcomings in the existing solutions.

For example, the cookie based approach is a common approach to detect and filter the request or received content. However, cookies are becoming less attractive and less effective. Further, most users know how to delete and bypass the cookies.

As a further example, DNT or tracking preference settings inside the browser may allow the remote node to know the user's preference. However, the DNT is not widely accepted because it may create business problems for advertisement companies. Thus, the adoptions of such UE based schemes and due to the lack of uniformity between browsers, devices make the DNT very difficult.

As another example, network based parental controls may be supported via DPI techniques where content may be examined, and request and response information towards the UE may be extracted. It has been observed that all application service providers (ASPs) are gradually moving towards encrypted SSL traffic, which makes network based parental control and DPI ineffective. Also, with hypertext transfer protocol (HTTP)/2, the middle boxes in the operator network do not have access to uniform resource locator (URL) information for URL filtering.

As a further example, parental control policies may be applied to fixed contents or files in the protocol or HTTP fields. Further, there is an increasing trend to move away from text based content to video based content. For example, user generated content (UGC), such as user created video content, is becoming more popular, and the content is becoming less of static web link or text. Performing video search or semantics are becoming increasingly difficult, making it harder to apply parental controls on the UGC videos.

Due to the above reasons, the ability to perform mobile operator network based parental control of the user traffic is not possible. Further, the ability to perform ASP/over the top (OTT) application server (in the Internet) based parental control of the user traffic is not possible (information of the user, such as, for example, age, is missing; no way to get the parental control intention from the user's parents). Additionally, the ability to capture user activity and reporting to the parent(s) is also not possible.

Certain embodiments of the invention make it possible to enable the operator and ASP to work to prevent inappropriate content from being presented to the user. It may also be possible to allow the operator to enable the parental control(s) for the user with the information of the content obtained from the ASP, such as, for example, 18+ content type or content rating [in case of a User Generated Content (UGC)]. It may further be possible to allow operators to control the parental control even for encrypted traffic, and allow the ASP to share the statistics and information including, for example, visited sites, mail and social network communications, instant messaging communications, etc., in the case of parental control enablement.

In an embodiment, a mechanism (for both in-band and off-band) to negotiate and receive the parental control policy from the network element inside the operator network (information provider) may be provided. In another embodiment, a mechanism to create the parental control policy information (PCP) and the possible ways to get it from policy servers, such as, for example, a policy and charging rules function (PCRF) in the case of a 3GPP based architecture may be provided.

Another embodiment provides a mechanism wherein a designated entity, such as a radio application cloud server (RACS) analytics agent (RAA) in RACS may be selected to interface with ASP networks. According to an embodiment, a mechanism that the designated entity (such as RAA in RACS) is allowed to represent the subscriber's PCP information without compromising on legal and privacy requirements may be provided.

In an embodiment, a mechanism that the designated entity (such as RAA in RACS) requests parental control policy enforcement at the ASP server may be provided. Alternatively, the designated entity (such as RAA in RACS) may retrieve the content type (for example, 18+ content or 12+ content, etc.) from the ASP server to perform the enforcement inside the mobile operator network. In an embodiment, the content may be delivered s per local government regulatory rules as the user generated content (UGC) rating may be country specific.

In another embodiment, a mechanism wherein ASP can reveal the subscriber's application usage/activity report without compromising legal and privacy requirements to the remote operator network may be provided. According to an embodiment, a mechanism wherein the operator network can identify encrypted flows with the information supplied by the ASP may also be provided.

In an embodiment, a mechanism that transparently works well at transport or tunnel mode encryption at the IP and SSL Layer may be provided. Further, in another embodiment, a mechanism that works well with 3G, Wi-Fi and LTE and beyond networks may also be provided. Additionally, in an embodiment, a mechanism that is transparent to IPv4 and IPv6 network architecture may be provided.

According to certain embodiments, a protocol may be specified to allow a functional entity, such as, for example, an information receiver (e.g., application server external to the operator network or the device) that resides outside the operator network to request for parental control from an information provider.

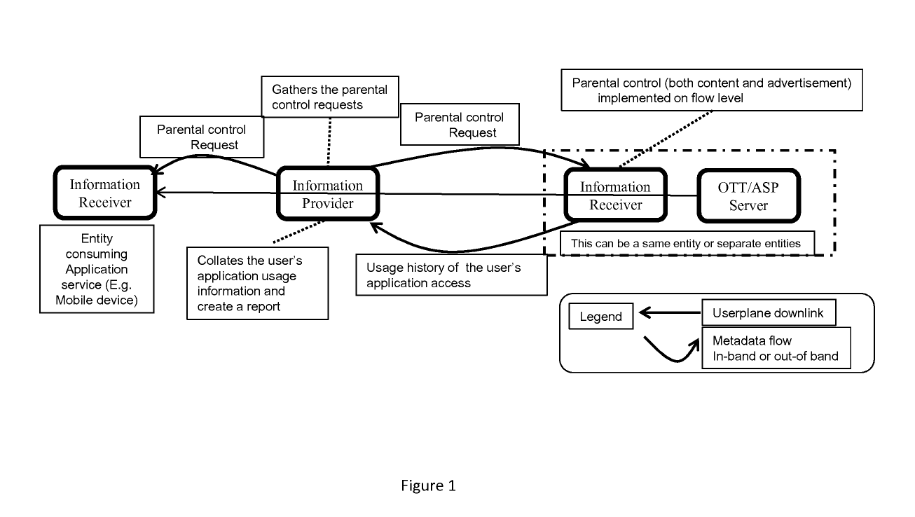

FIG. 1 illustrates a group of logical entities, according to certain embodiments. In particular, FIG. 1 shows that the information provider can be the application server that resides behind the core network of the operator or in the Internet. The information provider (e.g., network element) may signal to the information receiver (e.g., application server or device) a request for parental control (near-real time) at the uplink (UL) or downlink (DL) interface. The information receiver may support the parental control policy enforcement, and may provide a report on the application usage by the user for the specific parent control request at the DL interface.

Under a business negotiation over a protocol between a network element and the application server/device, in-band or out-of-band, or both, may be a way to transport the information. In an embodiment, the information receiver may be either a standalone middle box with the role to terminate the encrypted HTTP/any application flow, and perform a DPI of the application traffic, or running at the OTT/ASP application server. As shown in FIG. 1, the device may act as an information receiver. However, in that case, it may be left to the implementation on where the parental control policy enforcement resides. For example, the parental control policy enforcement may reside either in the application server or in the application client in the device. Further, the information provider may be any inline network entity anywhere in the wired/wireless operator network.

In an embodiment, in the case of a mobile network, the information provider may reside at a mobile edge computing (MEC) platform or mobile core, or any network element in the access network between the device and the Internet. Even in cases of wired networks the information provider can be part of any network element which is in line to the user plane traffic and has the capability to work on corresponding layer protocols used to transport the information (TCP, IP or HTTP).

A valid implementation may require the availability of a network side entity, such as, for example, the information provider, capable of creating the parental control request with the information from the core network elements. The information provider may also gather the parental control requests, which may ultimately be sent to the information receiver for implementation. Further, the information provider may collate the user's application usage information and create a report.

An Internet side entity, such as, for example, the information receiver may also be included. The Internet side entity may be capable of implementing the parental control mechanism including URL, content and advertisement filtering, for example. In addition, the information receiver may be capable of providing a user's activity report at the end of each flow. For example, in an embodiment, the information receiver may be capable of providing a user's activity report for every web session to the web server.

Further, a device side entity, such as, for example, the information receiver may also be included. The information receiver may be capable of implementing the parental control mechanism including URL, content and advertisement filtering or mediating the request to the Internet server side, for example. In addition, the information receiver may be capable of providing a user's activity report at the end of each flow, or mediate the report from the Internet server side. For example, in an embodiment, the information receiver may be capable of providing a user's activity report for every web session to the web server.

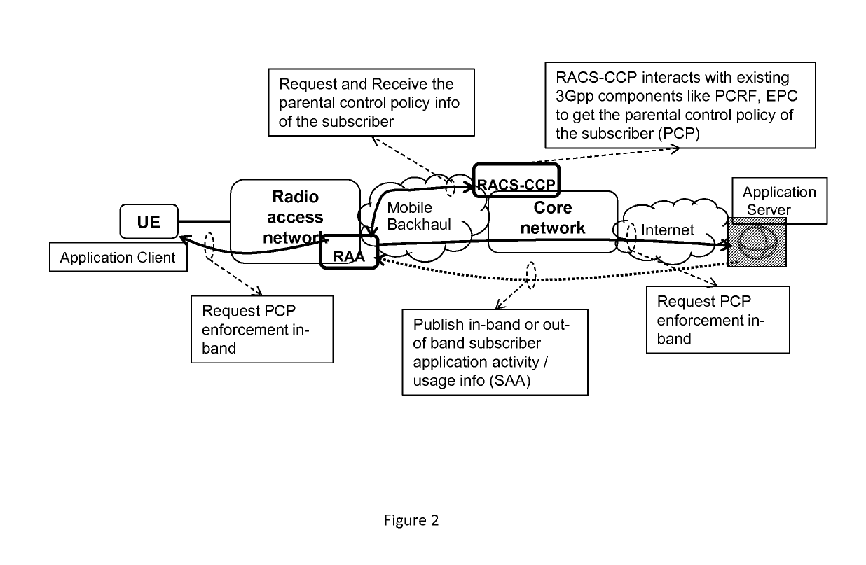

FIG. 2 illustrates an example implementation in an MEC platform of a mobile network, according to certain embodiments. In particular, FIG. 2 shows a possible implementation of a functionality including the information provider in the MEC platform (RACS) in a radio access network (RAN) of the mobile network, which may be called a RACS Analytics Agent (RAA). RAA may act as the information provider. In an embodiment, RAA may also be a software entity running on RACS scoped to continuously send the parental control request if needed for each transmission control protocol (TCP) flow to the application server or the UE that is transmitting data in the corresponding bearer.

As shown in FIG. 2, the application server or the UE may act as the information receiver. The parental control policy information (PCP) of the subscriber may be obtained from the core network elements through a central policy mediation component referred to as RACS-communication control port (CCP).

With the proposed method, the PCP of the subscriber related to the application flow may be available at the RAA immediately after the start of the application session. The RAA may obtain the subscriber's PCP information from the core network through a mediation component. In this implementation, the mediation component may include the RACS-CCP. The RACS-CCP may use existing 3GPP interfaces and/or components to obtain the PCP information of the subscriber. The 3GPP components may include the PCRF, an evolved packet core (EPC), or other similar components. By obtaining this information, the RAA may create a request for the PCP enforcement in-band at the UE or application server.

The PCP request may be passed to the information receivers either in-band via a protocol header, or via a dedicated off-band control connection. The PCP request receiver may be any entity in the external network. For example, the PCP request receiver may be an application server, content delivery network (CDN) node, origin server, adaptation gateway acting as a middle box in the Internet, application running in a device, or other similar entities.

The subscriber application usage or activity information (SAA) may be passed from the information receivers either in-band via a protocol header, or via a dedicated off-band control connection. The SAA information receiver may be any entity in the operator network. For example, as shown in FIG. 2, the SAA information receiver may be the RAA. The RAA may pass the subscriber application activity/usage information to the RACS-CCP where it is may be collated to create a report that may be shared with the parent on a need basis.

According to an embodiment, the report may include a variety of information. For example, the report may include, but not limited to: a report of visited sites; harmful and suspicious site alerts including user-generated site categories; mail and social network communication visibility; instant messaging communications visibility; reports on search engine usage; or an extended social graph view.

Adding information to the protocol headers may provide an efficient mechanism that piggybacks information on the user plane packets, thus the additional information is received by information receivers with its full context (i.e., including the UE, flow and application identity). The out-of-band connection is provided in case the arrival of the information through in-band is not guaranteed, e.g., due to intermediate firewalls stripping off the extra protocol headers. The PCP request transmitted via the off-band connection may require sending additional context information to identify the connection to which it corresponds. The in-band enrichment option may be done by adding optional/additional fields in the TCP header or IPV6 extension headers or HTTP header (in case of plain text) or even in payloads. In addition, both in-band and out-of-band information transfer mechanisms may have requirements on quality of service (QoS) and security. They may also have authentication and encryption mechanisms to provide the integrity and authenticity of the information.

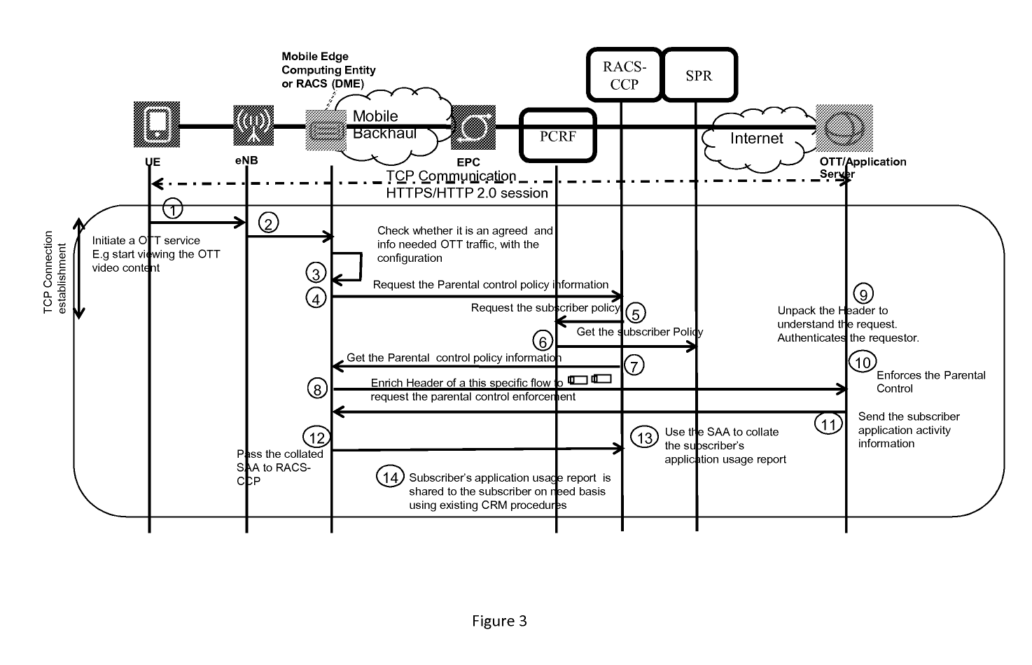

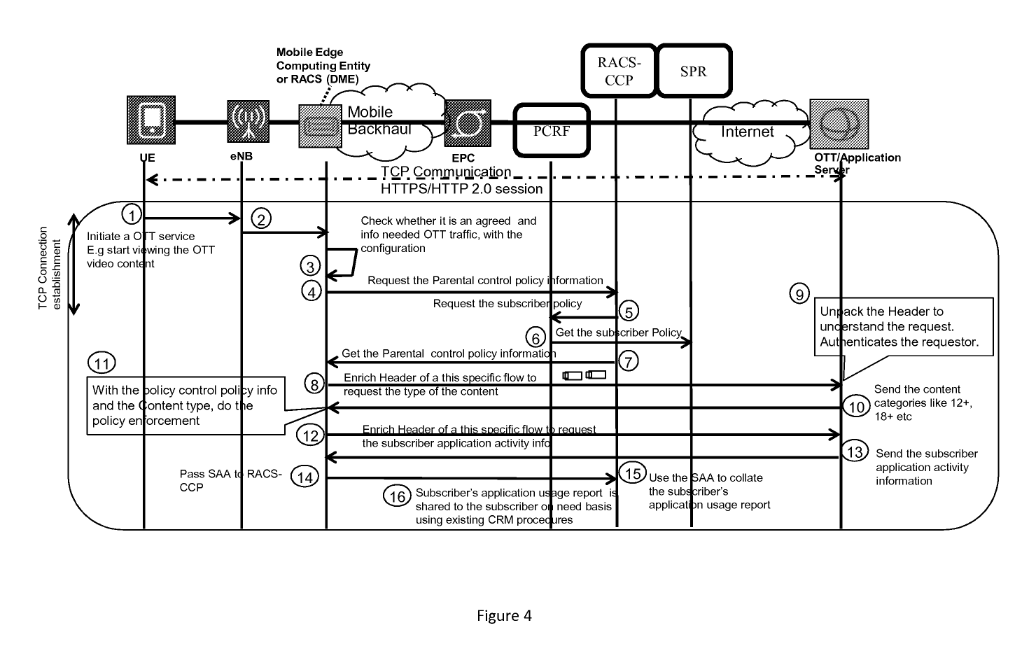

According to certain embodiments, there may be at least two approaches in which network based PCP can be implemented. For example, FIG. 3 and FIG. 4 illustrate two approaches by which an operator and ASP can work together and share information.

FIG. 3 illustrates an ASP assisted parental policy control implementation (Approach A), according to certain embodiments. In approach A, as shown in FIG. 3, the operator may request the ASP to implement the parental control enforcement at the source. The operator may also request that the ASP provide the detailed summary of the subscriber's application activity.

According to FIG. 3, a TCP connection may be established between the UE and OTT/application server. At 1, the UE may initiate an OTT service. For example, the UE may start viewing the OTT video content. At 2, the initiation of the OTT service may be indicated to the MEC entity or RACS. At 3, the MEC entity or RACS may check whether the initiation of the OTT service is agreed upon, and whether OTT traffic information is needed with the configuration.

At 4, the MEC entity or RACS may obtain parental control policy information of the subscriber by sending a request for parental control policy information to the RACS-CCP. At 5, the RACS-CCP may send a request for the PCP information of the subscriber to the PCRF. At 6, the PCRF may send the PCP information of the subscriber to the RACS-CCP in response to the request from the RACS-CCP. At 7, the RACS-CCP may send the PCP information of the subscriber to the MEC entity or RACS.

At 8, the MEC entity or RACS may send the PCP information of the subscriber to the OTT/application server using an enriched header. In an embodiment, the PCP information of the subscriber may be sent to the OTT/application server either in-band via a protocol header, or via a dedicated off-band control connection. At 9, the OTT/application server may unpack the header to understand the request, and authenticate the requestor. At 10, the OTT/application server may enforce the PCP of the subscriber, and at 11, the OTT/application server may send the subscriber application activity/usage information.

Once received, at 12, the subscriber application activity/usage (SAA) information may be collated to create a report and sent to the RACS-CCP. At 13, the RACS-CCP may use the SAA to collate the subscriber's application usage report. At 14, the subscriber's application usage report may be shared to the subscriber on a need basis using existing customer relationship management (CRM) procedures. Further, in an embodiment, communications at 1-3, 8 and 11 may be performed in the user plane (in-band), and communications at 4-7 and 13 may be performed in the control plane (out-of-band). Additionally, the TCP connection establishment, and the TCP communication established between the UE and OTT/application server may be performed in the user plane (in-band).

FIG. 4 illustrates an ASP assisted parental policy control implementation (Approach B), according to certain embodiments. In Approach B, as shown in FIG. 4, the operator may request the content type information. After getting to know that information, the operator may perform parental control policy enforcement (RAA or MEC server acts as a policy enforcement point (PEP) and does not forward the traffic to the user or apply respective policies on at the IP level).

According to FIG. 4, a TCP connection may be established between the UE and OTT/application server. At 1, the UE may initiate an OTT service. For example, the UE may start viewing the OTT video content. At 2, the initiation of the OTT service may be indicated to the MEC entity or RACS. At 3, the MEC entity or RACS may check whether the initiation of the OTT service is agreed upon, and whether OTT traffic information is needed with the configuration.

At 4, the MEC entity or RACS may obtain parental control policy information of the subscriber by sending a request for parental control policy information to the RACS-CCP. At 5, the RACS-CCP may send a request for the PCP information of the subscriber to the PCRF. At 6, the PCRF may send the PCP information of the subscriber to the RACS-CCP in response to the request from the RACS-CCP. At 7, the RACS-CCP may send the PCP information of the subscriber to the MEC entity or RACS.

At 8, the MEC entity or RACS may send, in an enriched header, a request to the OTT/application server for a specific type of content information that may be applied in performing parental control policy enforcement. In an embodiment, the PCP information of the subscriber may be sent to the OTT/application server either in-band via a protocol header, or via a dedicated off-band control connection. At 9, the OTT/application server may unpack the header to understand the request, and authenticate the requestor. At 10, in response to the MEC entity's or RACS's request, the OTT/application server may send the requested content categories, such as, for example, content based on the age of a user, including 12+ content, 18+ content, etc., to the MEC entity or RACS. Upon receipt, the MEC entity or RACS may, with the PCP information and the content type, perform policy enforcement.

At 11, the MEC entity or RACS may, with the policy control policy information and the content type, perform the policy enforcement. At 12, the MEC entity or RACS may send, in an enriched header, a request to the OTT/application server for the subscriber application activity information. In response, at 13, the OTT/application server may send the subscriber application activity information to the MEC entity or RACS, and at 14, the MEC entity or RACS may send the SAA information to the RACS-CCP where, at 15, the RACS-CCP may use the SAA to collate the subscriber's application usage report. At 16, the subscriber's application usage report may be shared to the subscriber on a need basis using existing CRM procedures. Further, in an embodiment, communications at 1-3 and 8, 10, 12 and 13 may be performed in the user plane (in-band), and communications at 4-7 and 14 may be performed in the control plane (out-of-band). Additionally, the TCP connection establishment, and the TCP communication established between the UE and OTT/application server may be performed in the user plane (in-band).

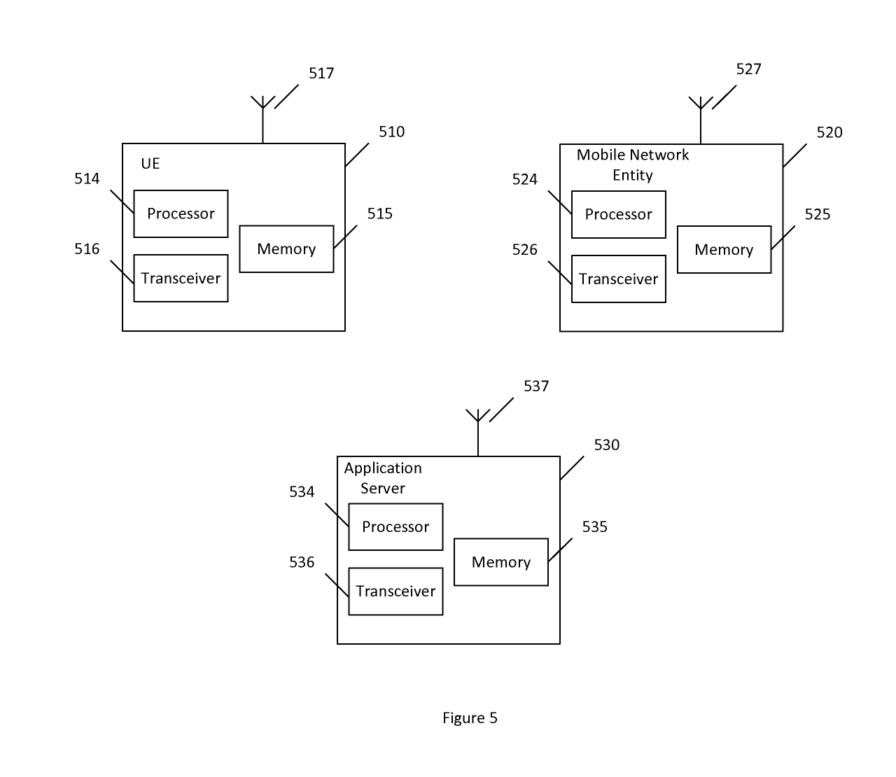

FIG. 5 illustrates an example of a system according to certain embodiments. In one embodiment, a system may include multiple devices, such as, for example, at least one UE 510, at least one mobile network entity 520 or base station or access point, and at least one application server 530.

Each of these devices may include at least one processor, respectively indicated as 514, 524, and 534. At least one memory can be provided in each device, and indicated as 515, 525, and 535, respectively. The memory may include computer program instructions or computer code contained therein. The processors 514, 524, and 534 and memories 515, 525, and 535, or a subset thereof, can be configured to provide means corresponding to the various blocks and processes of FIGS. 1-4, 7 and 8.

As shown in FIG. 5, transceivers 516, 526, and 536 can be provided, and each device may also include an antenna, respectively illustrated as 517, 527, and 537. Other configurations of these devices, for example, may be provided as well. For example, mobile network entity 520 may be configured for wired communication, in addition to wireless communication, and in such a case, antenna 527 can illustrate any form of communication hardware, without requiring a conventional antenna.

Transceivers 516, 526, and 536 can each, independently, be a transmitter, a receiver, or both a transmitter and a receiver, or a unit or device that is configured both for transmission and reception. For example, the transceivers 516, 526, and 536 may be configured to modulate information onto a carrier waveform for transmission by the antennas 517, 527, and 537, and demodulate information received via the antennas 517, 527, and 537 for further processing by other elements of the system shown in FIG. 5. In other embodiments, transceivers 516, 526, and 536 may be capable of transmitting and receiving signals or data directly.

Processors 514, 524, and 534 can be embodied by any computational or data processing device, such as a central processing unit (CPU), application specific integrated circuit (ASIC), or comparable device. The processors can be implemented as a single controller, or a plurality of controllers or processors. The processors may also perform functions associated with the operation of the system including, without limitation, precoding of antenna gain/phase parameters, encoding and decoding of individual bits forming a communication message, formatting of information, and overall control of the system, including process related to management of communication resources.

Memories 515, 525, and 535 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 510, mobile network entity 520, and application server 530, to perform any of the processes described herein (see, for example, FIGS. 1-4, 7 and 8). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 5 illustrates a system including a UE, network entity, and application server, embodiments of the invention may be applicable to other configurations, and configurations involving additional elements. For example, not shown, additional UEs may be present, Internet server side elements, mobile operator network elements, and additional core network elements may be present, as illustrated in FIGS. 1-4, for example.

As mentioned above, according to one embodiment, the system shown in FIG. 5 may include a UE 510, mobile network entity 520, and application server 530, for example. In an embodiment, a network element, such as, for example, mobile network entity 520, may be controlled by memory 525 and processor 524 to receive parental control policy information of a subscriber from a network entity in a core network. The mobile network entity 520 may also be controlled by memory 525 and processor 524 to initiate parental control policy enforcement according to parental control policy information. In an embodiment, the parental control policy enforcement may be initiated in at least one of a mobile network entity or an application service provider.

In another embodiment, the initiating may include performing at least one of implementing parental control policy enforcement according to parental control policy information, or sending a request to the application service provider to implement parental control policy enforcement according to the parental control policy information. The mobile network entity 520 may also be controlled by memory 525 and processor 524 to receive subscriber application usage or activity information, wherein the subscriber application usage or activity information is received either in-band via a protocol header, or via a dedicated off-band control connection. In an embodiment, the usage or activity information can be revealed by an application service provider without compromising legal and privacy requirements to a remote operator network. According to an embodiment, the mobile network entity may identify encrypted flows with the information supplied by the application service provider.

The mobile network entity 520 may further be controlled by memory 525 and processor 524 to pass the subscriber application usage or activity information to the network entity. The mobile network entity 520 may also be controlled by memory 525 and processor 524 to receive specific content type information of the subscriber according to the parental control policy information from an application service provider. In an embodiment, the specific content type information comprises content designated for a specific age of a user. For example, the content type may include 12+ content or 18+ content.

The mobile network entity 520 may further be controlled by memory 525 and processor 524 to implement parental control policy enforcement according to the specific content type information. In an embodiment the request for parental control policy information from the network entity is sent near-real time at an uplink or downlink interface. In another embodiment, the subscriber application usage or activity information may be collated to create a report that is shared to the subscriber on a need basis.

According to an embodiment, the report may include at least one of visited sites reports, harmful and suspicious site alerts including user-generated site categories, mail and social network communication visibility, instant messaging communications visibility, reports on search engine usage, or extended social graph view. In an embodiment, the parental control policy information is obtained from a core network entity. In another embodiment, the core network entity may include a policy and charging rules function or an evolved packet core. Further, according to an embodiment, the parental control policy enforcement may include a universal resource locator, content, or advertisement filtering.

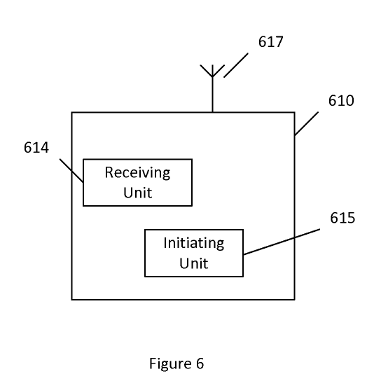

FIG. 6 illustrates an apparatus 610, according to certain embodiments. In one embodiment, the apparatus 610 may be a mobile network entity, such as, for example, a base station, evolved node B (eNB), or other access point, discussed above in connection with FIG. 5. It should be noted that one of ordinary skill in the art would understand that apparatus 610 may include components or features not shown in FIG. 6.

As illustrated in FIG. 6, apparatus 610 may include a receiving unit 614 that may be configured to receive parental control policy information of a subscriber from a network entity in a core network. The apparatus 610 may also include an initiating unit 615 configured to initiate parental control policy enforcement according to the parental control policy information. Additionally, the apparatus 610 may include one or more antennas 617 for transmitting and receiving signals and/or data to and from apparatus 610.

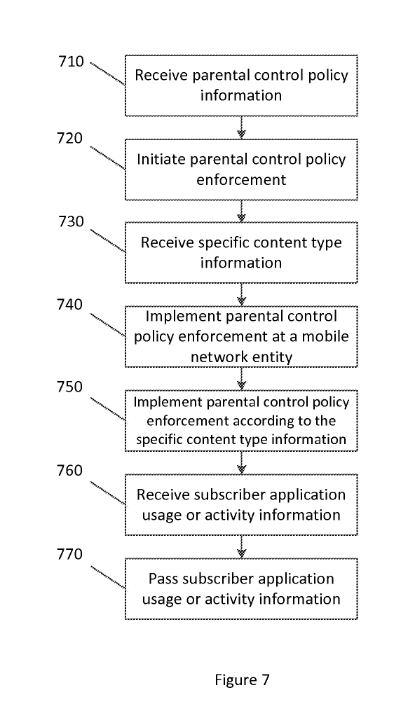

FIG. 7 illustrates an example of a flow diagram of a method, according to certain embodiments. In an embodiment, the method of FIG. 7 may be performed by a network entity of a network, such as, for example, a mobile network entity. The method may include, at 710, receiving parental control policy information of a subscriber from a network entity in a core network. The method may further include, at 720, initiating parental control policy enforcement according to the parental control policy information. In an embodiment, the parental control policy enforcement may be initiated in at least one of a mobile network entity or an application service provider.

The method may also include, at 730, receiving specific content type information of the subscriber according to the parental control policy information from an application service provider. In an embodiment, the specific content type information may include content designated for a specific age of a user. The method may further include, at 740, implementing parental control policy enforcement at a mobile network entity. The method may also include, at 750, implementing parental control policy enforcement according to the specific content type information. The method may further include, at 760, receiving subscriber application usage or activity information. In an embodiment, the subscriber application usage or activity information may be received either in-band via a protocol header, or via a dedicated off-band control connection. The method may also include at 770, passing the subscriber application usage or activity information to the network entity so that it may be shared to a subscriber on a need basis.

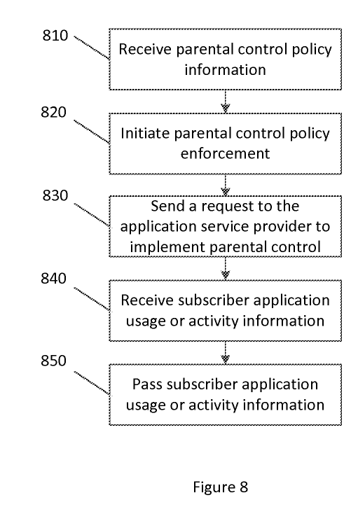

FIG. 8 illustrates an example of another flow diagram of a method, according to certain embodiments. In an embodiment, the method of FIG. 8 may be performed by a network entity of a network, such as, for example, a mobile network entity. The method may include, at 810, receiving parental control policy information of a subscriber from a network entity in a core network. The method may further include, at 820, initiating parental control policy enforcement according to the parental control policy information. In an embodiment, the parental control policy enforcement may be initiated in at least one of a mobile network entity or an application service provider.

The method may also include, at 830, sending a request to the application service according to the parental control policy information. The method may further include, at 840, receiving subscriber application usage or activity information. In an embodiment, the subscriber application usage or activity information may be received either in-band via a protocol header, or via a dedicated off-band control connection. The method may also include at 850, passing the subscriber application usage or activity information to the network entity so that it may be shared to a subscriber on a need basis.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### Glossary

3GPP 3rd Generation Partnership Project
ASIC Application Specific Integration Circuit
ASP Application Service Provider
CCP Communication Control Port
CDN Content Delivery Network
CPU Central Processing Unit
CRM Customer Relationship Management
DNT Do Not Track
DL Downlink
DPI Deep Packet Inspection
eNB Evolved Node B
EPC Evolved Packet Core
E-UTRAN Evolved UTRAN
FDD Frequency Division Duplexing
HDD Hard Disk Drive
HTTP Hypertext Transfer Protocol
IP Internet Protocol
LSO Locally Shared Objects
LTE Long Term Evolution
Mbps Megabits Per Second
MEC Mobile Edge Computing
OBA Online Behavioral Advertising
OTT Over The Top
PEP Policy Enforcement Point
PCP Parental Control Policy
PCRF Policy and Charging Rules Function
RAA RACS Analytics Agent
RACS Radio Application Cloud Server
RAM Random Access Memory
RAN Radio Access Network
RNC Radio Network Controllers
RNS Radio Network Subsystem
SAA Subscriber Application Activity
SSL Secure Sockets Layer
TDD Time Division Duplexing
UE User Equipment
UGC User Generated Content
UL Uplink
UMTS Universal Mobile Telecommunications System
URL Uniform Resource Locator
UTRAN Universal Mobile Telecommunications System Terrestrial Radio Access Network

1. A method, comprising:
receiving parental control policy information of a subscriber from a network entity in a core network;
initiating parental control policy enforcement according to the parental control policy information,
wherein the parental control policy enforcement is initiated in at least one of a mobile network entity or an application service provider.

2. The method according to claim 1, wherein the initiating comprises performing at least one of implementing parental control policy enforcement according to the parental control policy information, or sending a request to the application service provider to implement parental control policy enforcement according to the parental control policy information.

3. The method according to claim 1, further comprising receiving subscriber application usage or activity information, wherein the subscriber application usage or activity information is received either in-band via a protocol header, or via a dedicated off-band control connection.

4. The method according to claim 1, further comprising passing the subscriber application usage or activity information to the network entity.

5. The method according to claim 1, further comprising:
receiving specific content type information of the subscriber according to the parental control policy information from an application service provider,
wherein the specific content type information comprises content designated for a specific age of a user.

6. The method according to claim 1, further comprising implementing parental control policy enforcement according to the specific content type information.

7. The method according to claim 1, wherein the request for parental control policy information from the network entity is sent near-real time at an uplink or downlink interface.

8. The method according to claim 1, wherein the subscriber application usage or activity information is collated to create a report that is shared to the subscriber on a need basis.

9. The method according to claim 1, wherein the report comprises at least one of visited sites reports, harmful and suspicious site alerts including user-generated site categories, mail and social network communication visibility, instant messaging communications visibility, reports on search engine usage, or extended social graph view.

10. The method according to claim 1, wherein the parental control policy information is obtained from a core network entity.

11. The method according to claim 1, wherein the core network entity comprises a policy and charging rules function or an evolved packet core.

12. The method according to claim 1, wherein the parental control policy enforcement comprises a universal resource locator, content, or advertisement filtering.

13. An apparatus, comprising:
at least one processor; and
at least one memory including computer program code,
wherein the at least one memory and the computer program code are configured, with the at least one processor, to cause the apparatus at least to
receive parental control policy information of a subscriber from a network entity of a core network;
initiate parental control policy enforcement according to parental control policy information,
wherein the parental control policy enforcement is initiated in at least one of a mobile network entity or an application service provider.

14. An apparatus, comprising:
receiving means for receiving parental control policy information of a subscriber from a network entity in a core network;
initiating means for initiating parental control policy enforcement according to the parental control policy information,
wherein the parental control policy enforcement is initiated in at least one of a mobile network entity or an application service provider.

15. The apparatus according to claim 14, wherein the initiating means comprises means for performing at least one of implementing parental control policy enforcement according to the parental control policy information, or means for sending a request to the application service provider to implement parental control policy enforcement according to the parental control policy information.

16. The apparatus according to claim 14, further comprising receiving means for receiving subscriber application usage or activity information, wherein the subscriber application usage or activity information is received either in-band via a protocol header, or via a dedicated off-band control connection.

17. The apparatus according to claim 14, further comprising passing means for passing the subscriber application usage or activity information to the network entity.

18. The apparatus according to claim 14, further comprising:
receiving means for receiving specific content type information of the subscriber according to the parental control policy information from an application service provider,
wherein the specific content type information comprises content designated for a specific age of a user.

19. The apparatus according to claim 14, further comprising implementing means for implementing parental control policy enforcement according to the specific content type information.

20. The apparatus according to claim 14, wherein the request for parental control policy information from the network entity is sent near-real time at an uplink or downlink interface.

21. The apparatus according to claim 14, wherein the subscriber application usage or activity information is collated to create a report that is shared to the subscriber on a need basis.

22. The apparatus according to claim 14, wherein the report comprises at least one of visited sites reports, harmful and suspicious site alerts including user-generated site categories, mail and social network communication visibility, instant messaging communications visibility, reports on search engine usage, or extended social graph view.

23. The apparatus according to claim 14, wherein the parental control policy information is obtained from a core network entity.

24. The apparatus according to claim 14, wherein the core network entity comprises a policy and charging rules function or an evolved packet core.

25. The apparatus according to claim 14, wherein the parental control policy enforcement comprises a universal resource locator, content, or advertisement filtering.

26. A computer program, embodied on a non-transitory computer readable medium, the computer program configured to control a processor to perform the method according to claim 1.
